(19) United States
(12) Patent Application Publication
(10) Pub. No.: US 2013/0006890 A1
(43) Pub. Date: Jan. 3, 2013

(54) Method for Combining the Management and Administration of Mutual Fund and Exchange-Traded Fund Assets Using a Master-Feeder Arrangement

(76) Inventor: Thomas E. Faust, JR., Boston, MA (US)

(21) Appl. No.: 13/538,150

(22) Filed: Jun. 29, 2012

Related U.S. Application Data
(60) Provisional application No. 61/502,645, filed on Jun. 29, 2011.
(60) Provisional application No. 61/521,484, filed on Aug. 9, 2011.

(51) Int. Cl. G06Q 40/04; G06Q 40/06

(52) U.S. Cl. 705/36 R

(57) ABSTRACT

A Mutual fund and ETF master-feeder arrangement includes a Mutual Fund module for a feeder mutual fund that issues and redeems mutual fund shares in transactions with investors primarily for cash, an ETF module for a feeder ETF that issues and redeems ETF shares in transactions with Authorized Participants through in kind transfers, and a Master Portfolio module for a master portfolio that issues and redeems interests through in-kind transactions with the Mutual Fund and the ETF. The Mutual Fund applies cash invested by mutual fund investors to purchase securities in accordance with an asset configuration communicated by the master portfolio; and the ETF conforms the composition of assets received in in-kind transactions to the asset configuration. The Mutual Fund and the ETF increase interests in the master portfolio by contributing assets, wherein transactions in securities to accommodate feeder fund inflows occur outside of the master portfolio.

### RELATED APPLICATION

This application claims the benefit of U.S. Provisional Patent Applications Ser. Nos. 61/502,645, entitled Hub and Spoke Fund of Funds Having Open-end and Exchange-Traded Shares, filed on Jun. 29, 2011; and 61/521,484, entitled Method for Combining the Management and Administration of Mutual Fund and Exchange-Traded Fund Assets Using a Master-Feeder Arrangement, filed on Aug. 9, 2011, the contents both of which are incorporated herein by reference in their entireties for all purposes.

### BACKGROUND

1. Technical Field

This invention relates to asset management and administration, and more particularly to an automated system and method for efficiently combining mutual fund and exchange-traded fund (ETF) assets into a single portfolio.

2. Background Information

Throughout this application, various publications, patents and published patent applications are referred to by an identifying citation. The disclosures of the publications, patents and published patent applications referenced in this application are hereby incorporated by reference into the present disclosure.

Efficiencies in the management and administration of two or more mutual funds of the same sponsor that follow similar investment programs may be achieved by the funds investing in a common underlying investment vehicle. In what is referred to as a “master-feeder” arrangement, (feeder) funds held primarily by outside investors invest all or a portion of their assets in an affiliated (master) fund that holds a portfolio of securities or other investments. U.S. Pat. No. 5,193,056, entitled “Data Processing System for Hub and Spoke Financial Services Configuration,” relates to methods and processes in connection with the master-feeder fund structure. Rather than holding all of its securities and other investments directly, a feeder fund invests indirectly in the securities and other investments of the affiliated master fund. Master funds are normally structured and operated so as to be treated as partnerships for U.S. federal income tax purposes, allowing for the flow-through of income, expenses, gains, losses and other tax items to the underlying (feeder) funds. Master funds may also be treated as regulated investment companies for U.S. federal income tax purposes. Feeder funds may invest exclusively in a single master fund or invest in multiple master funds of the same sponsor.

Mutual funds and ETFs of the same sponsor may similarly achieve efficiencies in management and administration by combining their investment programs using a master-feeder structure. In applying the master-feeder structure to underlying mutual funds and ETFs, care must be taken to preserve the distinctive features and benefits of each fund type. Whereas mutual funds effect purchases and redemptions of fund shares primarily in cash, ETFs have generally prescribed that purchases and redemptions of their shares be made “in kind” through the delivery of specified portfolio securities or, alternatively, required that cash purchases and redemptions be accompanied by the payment of a fee intended to cover the trading and other costs incurred by the fund in connection with the purchase or redemption. The use of in-kind purchases and redemptions (and/or purchase and redemption fees on cash transactions) enhances an ETF's returns by lowering its portfolio trading costs, shielding continuing shareholders from costs in connection with accommodating the inflows and outflows of transacting shareholders.

Using distributions of portfolio securities to meet shareholder redemptions may also materially enhance an ETF's tax efficiency in comparison to similarly constituted mutual funds. An adverse tax effect of investing in conventional mutual funds is that a fund's sales of appreciated securities to raise cash to meet redemptions may trigger capital gains realizations for the fund's other shareholders. Funds that utilize in-kind distributions of securities to meet redemptions may largely avoid this adverse tax effect. Section 852(b)(6) of the Internal Revenue Code provides that a fund's distributions of appreciated property to meet shareholder redemption requests do not result in recognition by the fund of capital gains on the distributed property. The fact that ETF creations and redemptions take place in Creation Unit aggregations of shares effected through designated Authorized Participants gives ETFs a practical ability to utilize in-kind redemptions (and achieve the associated tax benefits) that broadly held mutual funds generally do not have.

U.S. Pat. No. 6,879,964 issued on Apr. 12, 2005, to George U. Sauter and Walter Lenhard and assigned to The Vanguard Group, Inc., discloses an “Investment Company that Issues a Class of Conventional Shares and a Class of Exchange-Traded Shares in the Same Fund.” Such patent contemplates the issuance of an exchange-traded share class by a mutual fund also having one or more other share classes that issued and redeem shares for cash, typically without payment of a purchase or redemption fee. By its nature, this structure allows some of the performance and tax-efficiency benefits of the ETF structure to be enjoyed by the fund's investors, both ETF class and conventional class. But, relative to a standalone ETF, the performance and tax-efficiency advantages to an ETF-class investor are diluted by the cash purchase and redemption activities of the fund's conventional-class shareholders.

### SUMMARY

One aspect of the invention includes a computer-implemented method for combining the management and administration of mutual fund and exchange-traded fund assets using a master-feeder arrangement. This method includes associating a Mutual Fund module with a feeder mutual fund that issues and redeems mutual fund shares in transactions with investors primarily for cash, associating an Exchange Traded Fund (ETF) module with a feeder ETF that issues and redeems ETF shares in transactions with Authorized Participants through one or more of in kind transfers of securities and cash, and associating a Master Portfolio module with a master portfolio of investments that issues and redeems interests in the master portfolio in one or more of in-kind and cash transactions with the Mutual Fund and the ETF. The Master Portfolio module is communicably coupled in a master-feeder arrangement with the Mutual Fund module and the ETF module. The Master Portfolio module directs the Mutual Fund module to apply cash invested by the mutual fund investors to purchase securities in accordance with an asset configuration communicated by the master portfolio module; and directs the ETF module to conform the composition of the one or more of securities and cash received in the in-kind transactions with the Authorized Participant, with the asset configuration. The Master Portfolio module directs the Mutual Fund module and the ETF module to effect increases in interests in the master portfolio by contributing the asset configuration to effect investor purchases, so that transactions in securities to accommodate feeder fund inflows occur outside of the master portfolio, while both the feeder mutual fund and the feeder ETF hold indirect interests in securities of the master portfolio, as well as transitory direct investments in securities in connection with shareholder purchases and redemptions.

In another aspect of the invention, an article of manufacture for combining the management and administration of mutual fund and exchange-traded fund assets using a master-feeder arrangement includes a computer usable medium having a computer readable program code embodied therein for implementing the foregoing method.

Still another aspect of the invention includes a computer-implemented system for combining the management and administration of mutual fund and exchange-traded fund assets using a master-feeder arrangement. The system includes a Mutual Fund module configured to direct operation of a feeder mutual fund that issues and redeems mutual fund shares in transactions with investors primarily for cash; an Exchange Traded Fund (ETF) module configured to direct operation of a feeder ETF that issues and redeems ETF shares in transactions with Authorized Participants through one or more of in kind transfers of securities and cash; and a Master Portfolio module configured to direct operation of a master portfolio of investments that issues and redeems interests in the master portfolio in one or more of in-kind and cash transactions with the Mutual Fund module and the ETF module. The Master Portfolio module is configured for being communicably coupled in a master-feeder arrangement with the Mutual Fund module and the ETF module. The Master Portfolio module is configured to direct the Mutual Fund module to apply cash invested by the mutual fund investors to purchase securities in accordance with an asset configuration communicated by the master portfolio module; and to direct the ETF module to conform the composition of the one or more of securities and cash received in the in-kind transactions with the Authorized Participant, with the asset configuration. The Master Portfolio module is also configured to direct the Mutual Fund module and the ETF module to effect increases in interests in the master portfolio by contributing the asset configuration to effect investor purchases, so that transactions in securities to accommodate feeder fund inflows occur outside of the master portfolio, while both the feeder mutual fund and the feeder ETF are configured to hold indirect interests in securities of the master portfolio, as well as transitory direct investments in securities in connection with shareholder purchases and redemptions.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1A is a block diagram of an embodiment of a master-feeder system of the present invention;

FIG. 1B is a functional block diagram showing various transactional aspects of an embodiment of the present invention;

FIG. 1C is a diagrammatic representation of an embodiment of an automated fund system within which the embodiments of FIGS. 1A and 1B may be incorporated;

FIGS. 2A and 2B are flow charts of a method for issuing shares in accordance with aspects of the present invention;

FIGS. 3A and 3B are flow charts of a method for redeeming shares in accordance with aspects of the present invention; and

FIG. 4 is a block diagram of one embodiment of a computer system usable with any of the embodiments of FIGS. 1-3B.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

The present inventor has recognized that combining the investment operations of an ETF and a minoring mutual fund of the same sponsor using a master-feeder structure may offer significant advantages over the prior art of a multi-class fund (e.g., the aforementioned U.S. Pat. No. 6,879,964). Whereas the performance and tax-efficiency advantages that an ETF can offer its shareholders are inherently diluted by structuring the ETF as a share class of a conventional mutual fund, use of the master-feeder structure as disclosed herein enables an ETF to retain those benefits while also capturing the operating efficiencies and economies of scale of co-investing alongside a minoring mutual fund.

A representative embodiment of the inventive approach described herein involves a master-feeder (also variously referred to as a fund-of-fund) arrangement with one or more master funds (master portfolios) having both mutual fund and ETF feeder funds. In this embodiment, mutual funds and ETFs under common sponsorship own interests in one or more of the same affiliated master portfolios, which in turn may hold individual securities and/or other investments. A master portfolio would be protected against incremental trading costs and potential capital gains realizations in connection with accommodating inflows and outflows from feeder fund shareholders by transacting with its feeder funds (both mutual fund and ETF) primarily using portfolio securities rather than cash. Purchases and sales of portfolio securities to accommodate feeder fund inflows and outflows would normally take place at the associated feeder fund, rather than being pushed to the master portfolio level. In another embodiment, feeder funds would transact with a master portfolio in cash, and the master portfolio would impose creation and redemptions fees designed to offset the trading and other costs to the master portfolio of accommodating the feeder fund's cash inflows and outflows.

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

Where used in this disclosure, the term “mutual fund” refers to open-end investment companies registered under the Investment Company Act of 1940, as amended (Investment Company Act). Mutual funds permit their shareholders to redeem their share interests each business day at a price based on the fund's next-determined net asset value.

The term “ETF” and/or “exchange-traded fund” refers to registered open-end investment companies or unit investment trusts that operate in reliance on a series of exemptions granted by the U.S. Securities and Exchange Commission (SEC) beginning in 1993 to certain provisions of the Investment Company Act. Retail and most institutional investors normally buy and sell ETF shares through secondary market transactions on an exchange. Transactions with the ETF itself (i.e., primary market transactions) are restricted to broker-dealers designated as “Authorized Participants” who purchase and redeem “Creation Unit” aggregation of shares from the ETF at net asset value. Market trading prices of ETF shares are linked to current net asset values by an arbitrage mechanism. Market makers and other arbitrageurs who buy and sell fund shares on the open market may earn arbitrage profits by entering into offsetting hedge positions in the underlying securities and other instruments, and using creations and redemptions of ETF shares in Creation Unit quantities through Authorized Participants to manage their ETF and hedge inventory.

The term “computer” is meant to encompass a workstation, personal computer, personal digital assistant (PDA), wireless telephone, or any other suitable computing device including a processor, a non-transitory computer readable medium upon which computer readable program code (including instructions and/or data) may be disposed, and a user interface. The term “server” is intended to refer to a computer-related component, including hardware, software, and/or software in execution. For example, a server may include, but is not limited to being, a process running on a processor, a processor including an object, an executable, a thread of execution, a program, and a computer. Moreover, the various components may be localized on one computer and/or distributed between two or more computers. The term “real-time” refers to sensing and responding to external events nearly simultaneously (e.g., within milliseconds or microseconds) with their occurrence, or without intentional delay, given the processing limitations of the system and the time required to accurately respond to the inputs.

Systems and methods embodying the present invention may be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology may be employed, such as, but not limited to, Microsoft SQL Server or IBM AS 400.

Embodiments of the present invention will be more thoroughly described, with reference to the appended figures. In this regard, an aspect of the invention includes the recognition that, since 2006, mutual funds have been permitted to combine investments in one or more master portfolios with direct holdings of a broad range of securities. SEC Rule 12d1-2, effective Jul. 31, 2006, expands the permissible direct investments of mutual funds that invest in affiliated funds of funds from U.S. government securities and short-term paper to include all securities not issued by investment companies, as well as certain investment company securities.

The present inventor has recognized that significant investor benefits may be achieved if one or more mutual funds and ETFs of the same sponsor combine their assets using a master-feeder structure. To ensure fair treatment of all its direct and indirect shareholders, a master portfolio configured in accordance with embodiments of the present invention maintains equitable purchase and distribution policies that apply to mutual fund and ETF feeder funds alike. The present inventor has also recognized that to preserve the shareholder protection and benefits (including tax benefits) of ETFs derived from their distribution of securities to meet redemptions, a master portfolio in which an ETF feeder invests should operate in a manner compatible with this practice.

Master portfolios operating as open-end investment companies registered under the Investment Company Act are permitted to meet redemptions of affiliated feeder funds in kind through the distribution of portfolio securities, provided that certain conditions described in a “no-action” letter issued by the SEC staff in December 1999 are met. (Response of the Office of Chief Counsel, SEC Division of Investment Management, to Signature Financial Group, Inc. dated Dec. 28, 1999. SEC Ref. No. 99-825). Such conditions include that: (a) the redemption in kind is effected at approximately the feeder fund's proportionate share of the master portfolio's current net assets; (b) the distributed securities are valued in the same manner as used in computing the master portfolio's net asset value; (c) the distribution is consistent with the master portfolio's publicly disclosed redemption policies and undertakings; (d) neither the redeeming feeder fund “nor any other party with the ability and the pecuniary incentive to influence the redemption in kind” selects, or influences the selection of, the distributed securities; (e) the redemption is effected pursuant to procedures adopted by the master portfolio's board of directors, including a majority of the independent directors, and they approve the redemption upon a finding that the redemption does not favor the redeeming feeder fund to the detriment of any other shareholder or favor the master portfolio to the detriment of the redeeming feeder fund and is in the best interests of the master portfolio; and (f) specified records in connection with each redemption in kind are maintained for at least six years after the end of the fiscal year in which the redemption occurs.

Embodiments of the present invention are configured to satisfy these conditions using a master portfolio having feeder funds that include one or more ETFs. An ETF feeder fund is configured to use in-kind purchases and/or redemptions of master portfolio securities in a manner substantially similar to that conventionally used to issue and redeem ETF shares. The securities a feeder ETF receives upon the in-kind purchase of its shares by or through an Authorized Participant would generally be invested in the associated master portfolio to increase the feeder ETF's investment therein. The securities a feeder ETF distributes in connection with an in-kind redemption of its shares by or through an Authorized Participant would normally be sourced from the associated master portfolio. To avoid favoring one set of feeder fund investors over another, a master portfolio that utilizes in-kind purchases and redemptions for feeder ETFs may transact with its mutual fund feeders on the same basis, accepting incremental investments primarily in the form of securities, rather than cash, and meeting redemptions also primarily in securities. Since most mutual funds are designed to transact with their shareholders in cash, this would normally require a feeder mutual fund to use shareholder net cash inflows to buy (at the feeder fund level) securities that it then contributes to the master portfolio to increase its investment therein, and to sell (at the feeder fund level) the securities it receives in connection with in-kind redemptions of master portfolio interests to fund shareholder net cash outflows. As long as each feeder fund transacts with master portfolios on the same basis, mutual funds and ETFs offered by the same sponsor and pursuing substantially similar investment programs may take advantage of the operating efficiencies associated with pooling investments into a commonly managed entity. The benefits of using the master-feeder structure may be particularly advantageous for a newly formed ETF that seeks to replicate an established mutual fund of the same sponsor.

The embodiments shown and described herein thus include methods and processes for combining the management and administration of mutual fund and ETF assets using a master-feeder arrangement. These embodiments represent an advancement relative to master-feeder prior art (e.g., the aforementioned U.S. Pat. No. 5,193,056) by incorporating additional data processing systems and methods to provide one or more of the following: (a) extend the range of subject feeder funds to encompass ETFs (and variations thereon) as well as mutual funds, common trust funds, offshore investment funds and pension fund and insurance company separate accounts; (b) expand the number of affiliated master portfolios in which a given feeder fund may invest from a single master portfolio to a substantially unlimited number; (c) provide for the regular use of portfolio securities as the medium for purchase and redemption transactions in master portfolio interests by ETF and other feeder funds; (d) facilitate the purchase and sale of master portfolio transaction securities by mutual fund and other feeder fund investors that transact primarily in cash with their own investors; and (e) provide for the calculation and imposition of appropriate fees on feeder fund purchases and redemptions of master portfolio interests that are effected in cash.

As noted above, under circumstances in which it may not be practicable or desirable for a feeder fund to transact directly in securities, a master portfolio may impose a transaction fee on feeder fund cash inflows and/or withdrawals. Such transaction fees would be used to reimburse the master portfolio for the trading and other costs it incurs to accommodate the feeder fund's cash flows and maintain investment holdings at desired levels and composition. In this manner, feeder funds (both mutual funds and ETFs) may be protected against indirect exposure to the flow accommodation costs of other feeder funds that invest in the same master portfolio, even under circumstances in which feeder funds transact with the master portfolio in cash rather than by transferring securities.

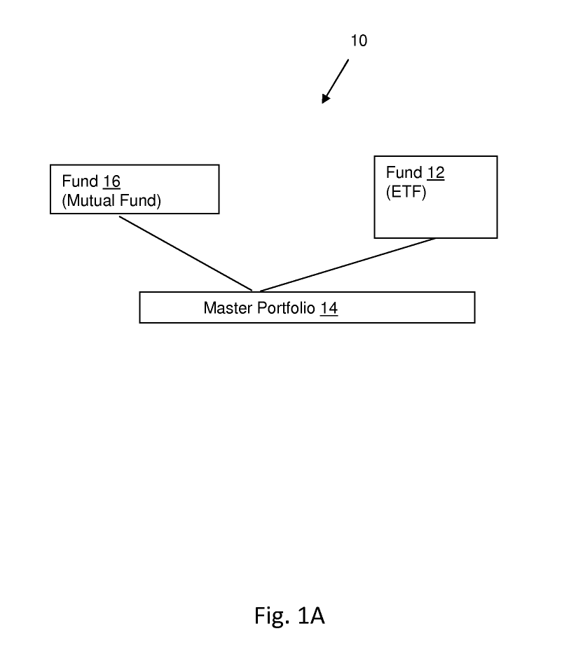

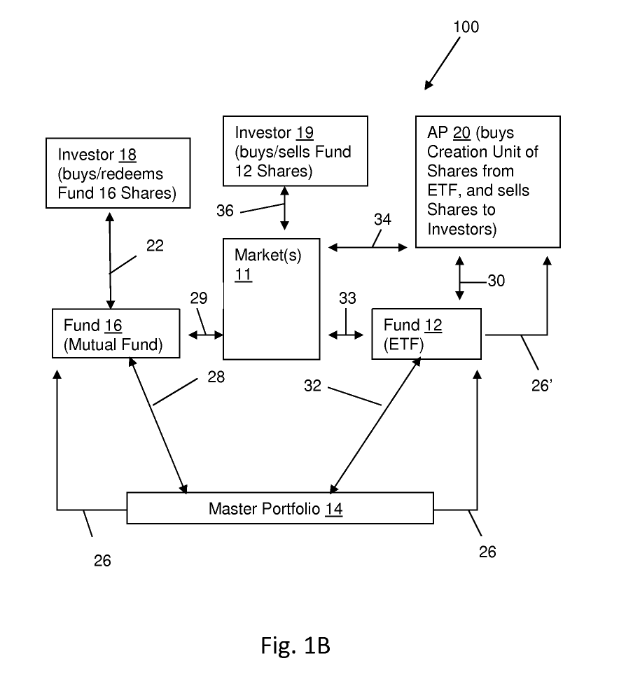

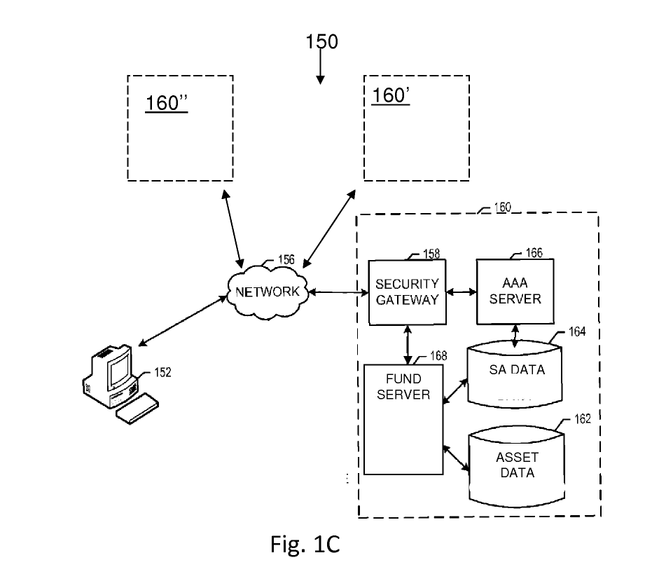

Turning now to FIG. 1A, an embodiment of the present invention shown as master-feeder system 10 enables indirect interests in a single Master Portfolio implemented by Master Portfolio module 14 to be offered to investors both via an ETF feeder fund implemented by Fund module 12 and a mutual fund feeder fund implemented by Fund module 16. Different investors may find either the ETF or mutual fund vehicle best suited to their particular needs. A fund sponsor who offers its investment strategies in both mutual fund and ETF format may enhance its business prospects by expanding investor choice to serve a broader range of customers.

It should be noted that in the embodiments shown and described herein, the various modules 12, 14 and 16 may either implement, or direct the implementation of, the various operations shown and described herein without departing from the scope of the present invention. For ease of explanation, the following embodiments will be shown and described with the modules 12, 14 and 16 implementing the various operations themselves. Also for ease of explanation, in the following description, the modules 12, 14, 16, and the funds/portfolios they implement and/or direct, are used interchangeably.

Referring now to FIG. 1B, a particular embodiment shown at system 100, includes a feeder ETF module 12 configured to implement investments in a new or existing Master Portfolio implemented by module 14 and a new or existing feeder Mutual Fund implemented by module 16 that invests in the same Master Portfolio in a manner that avoids diluting the shareholder benefits of the ETF structure for ETF module 12. As shown, the Mutual Fund module 16 may engage in transactions 22 with investors 18, in transactions 28 with Master Portfolio 14, and in transactions 29 with one or more secondary markets 11. The ETF module 12 may engage in transactions 32 with Master Portfolio 14, in transactions 30 with Authorized Participants (APs) 20, and in transactions 33 with the market 11. The AP 20 may engage in transactions 34 with the market 11. Investors 19 may then purchase and sell shares of ETF 12 through the secondary market 11, such as at transaction 36.

In this regard, Mutual Fund module 16 may accept cash from investors 18 in exchange for shares in Mutual Fund 16 at transaction 22. Mutual Fund 16 may then use this cash to purchase securities, e.g., in market transaction 29, in an asset configuration determined by the Master Portfolio module 14 and communicated to Fund module 16 at 26. Fund module 16 may then contribute the purchased securities to the Master Portfolio 14 via transaction 28 to increase Mutual Fund 16's interest in the Master Portfolio 14.

When Mutual Fund 16 needs cash to meet shareholder redemptions, securities selected by the Master Portfolio module 14 are transferred to Mutual Fund 16 from the Master Portfolio module 14 at 28, reducing Mutual Fund 16's interest in the Master Portfolio by a corresponding amount. Mutual Fund module 16 may then sell the securities transferred to it by the Master

Portfolio module 14 to provide the cash to fund the redemptions at 22. With this approach, trading of securities in connection with purchases and redemptions of Mutual Fund module 16 shares may be isolated to Mutual Fund module 16 rather than taking place at the Master Portfolio level, thereby protecting the ETF and its shareholders from the costs and potential tax effects associated with the purchases and redemptions by investors 18 of Mutual Fund 16.

The ETF feeder fund module 12 transacts with the Master Portfolio module 14 in a manner that is substantially similar to that describe with respect to Mutual Fund module 16. Initially, at 30, ETF module 12 may issue its shares to Authorized Participants 20 in Creation Unit aggregations in exchange for the securities and cash specified as ETF 12's current Creation Basket communicated to AP 20 at 26′. It should be noted that in particular embodiments, the current Creation Basket may be determined by Fund 12, with a close correspondence to the asset configuration 26 generated by Master Portfolio 14 as described hereinabove. To the extent that ETF module 12 needs to reconcile the securities and cash included in its current Creation Basket 26′ with what the Master Portfolio module 14 then desires to receive, as indicated at 26, the associated purchases and sales of securities may take place at the feeder fund level, i.e., via transaction 33 with market 11, rather than in the Master Portfolio 14. ETF module 12 may then transfer the reconciled Creation Basket securities to the Master Portfolio module 14 at 32, to increase its interest in the Master Portfolio 14.

When an Authorized Participant 20 redeems ETF shares, ETF module 12 may reduce its interest in the Master Portfolio by a corresponding amount in exchange for securities provided by the Master Portfolio 14. To the extent that the securities ETF 12 receives from the Master Portfolio module 14 (e.g., as indicated at 26) do not correspond to its current Redemption Basket (e.g., at 26′), ETF module 12 may make reconciling purchases and/or sales of securities at the feeder fund level (via a market transaction 33) and then distribute the Redemption Basket 26′ to the redeeming Authorized Participant at 30 to effect the redemption. With this approach, purchases and sales of Master Portfolio securities in connection with purchases and redemptions of ETF shares are isolated to ETF 12, to effectively protect Mutual Fund module 16 and its shareholders from the associated Master Portfolio trading costs and potential tax realizations.

Investing the assets of Mutual Fund module 16 and ETF module 12 in the Master Portfolio module 14 in this manner provides economies of scale benefits to each feeder fund while protecting them against incremental trading costs and capital gain realizations in connection with the other feeder fund's shareholder transactions. These protections help to maintain the full benefits of in-kind creations and redemptions for an ETF (or mutual fund) that transacts with its shareholders primarily on that basis and which invests alongside a mutual fund (or ETF) that meets shareholder purchases and redemptions in cash.

The methods and systems described herein may be applied to mutual fund and ETF feeder funds of substantially all descriptions, as well as feeders that are common trust funds, offshore investment funds, pension fund and insurance company separate accounts, and combinations thereof. The embodiments described herein involve the transfer of securities between various entities including ETF Fund 12, Mutual Fund module 16, the Master Portfolio 14, Authorized Participants 20, investors, and various securities markets. It should be understood that the transfer of such securities may be performed electronically via suitable messaging formats and systems well known to those of skill in the art. For instance, the DTC (Depository Trust Company) provides a participant terminal system for transferring securities using electronic messaging. Thus, an electronic transfer of securities may be performed by sending an electronic message to the DTC. The DTC then performs a book entry movement by executing an accounting entry to move securities from one account to another account.

Master Portfolio 14 may be actively managed, meaning that its manager or advisor applies investment judgment to determine the contents of its securities holdings. While the Portfolio module 14 may retain the ability to make such alterations to the Master Portfolio directly via market transactions 11, in particular embodiments the manager or advisor may primarily alter the holdings of the Portfolio through in-kind exchanges 28 and 32, with Fund modules 12 and 16 as described herein, e.g., with the desired alterations reflected in the asset configurations 26 disseminated by the Portfolio 14.

An ETF Authorized Participant 20 may be a bank, broker-dealer, exchange specialist, market maker, arbitrageur or other institutional investor, and/or a combination thereof, configured to purchase and redeem Fund shares in Creation Unit aggregations in exchange for baskets of securities or cash as specified by the ETF. The AP enters into an agreement with the Fund setting the terms for in-kind transactions, which may include the obligation to maintain the confidentiality of the Creation/Redemption Basket configurations provided at 26′. The Funds 12 and 16 may enter into similar agreements with Master Portfolio 14, including the obligation to maintain the confidentiality of asset configurations 26.

With reference to FIG. 1C, an automated Fund system 150, including a system of networked, specially configured computers, may be used to implement various transactions and data transfers associated with operation of the embodiments described herein. The system 150 may include an AP workstation 152 and a Fund system 160 for the Master Portfolio 14. Fund system 160 may include Fund server 168, a database 162 containing information relating to the Fund portfolio securities and asset configurations, and database 164 containing data relating to the AP 20 and Funds 12 and 16, such as identification information, password files, encryption keys, other access authorization and accounting (AAA) data. In this regard, Fund system 160 may optionally include AAA server 166 and a security gateway 158. The various components communicate over network 156, which may be a public network such as the Internet, or a private network including leased lines, or a virtual private network using virtual private network (VPN) protocols. System 150 may also include additional Fund systems 160′ and 160″, e.g., to embody ETF module 12 and Fund module 16, respectively. Fund systems 160′ and 160″ may be substantially similar to Fund system 160.

In particular embodiments, the various transactions and transfers described herein may take place using the systems and components shown in FIG. 1C, although one of skill in the art will appreciate that many variations of the system may be implemented without departing from the scope of the invention. Suitable networking protocols may be used, including the Transport Control Protocol/Internet Protocol (TCP/IP) suite of protocols, and also including the HyperText Transport Protocol (HTTP) and associated security protocols HTTPS, and other mechanisms such as Virtual Private Networking (VPN), Secure Sockets Layer (SSL), Transport Layer Security (TLS), tunneling protocols such as Generic Routing and Encapsulation (GRE), Layer 2 Tunneling Protocol (L2TP), and the like. Another protocol that may be used to facilitate the transactions and associated messaging described herein is the Financial Information eXchange (FIX) Protocol, which is a messaging standard developed specifically for the real-time electronic exchange of securities transactions. FIX is a public-domain specification owned and maintained by FIX Protocol, Ltd. In addition, some of the transactions may be communicated in a manual fashion, such as via telephone or textual messaging (email, and the like), whereupon the relevant transaction information may be entered into the appropriate computer systems.

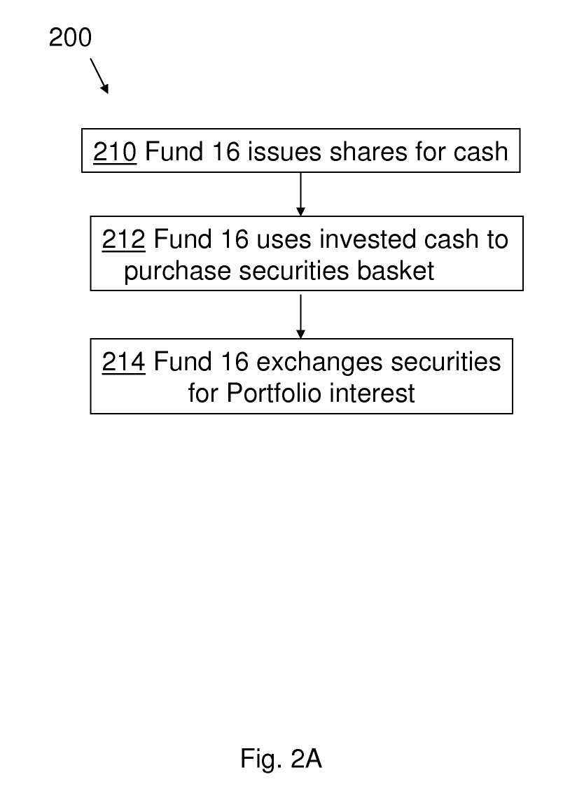

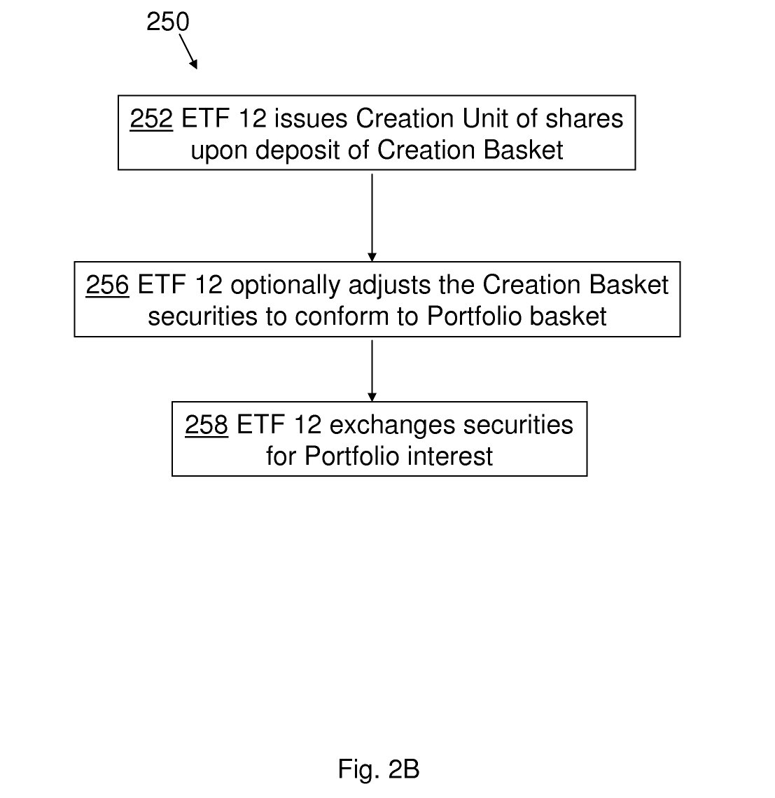

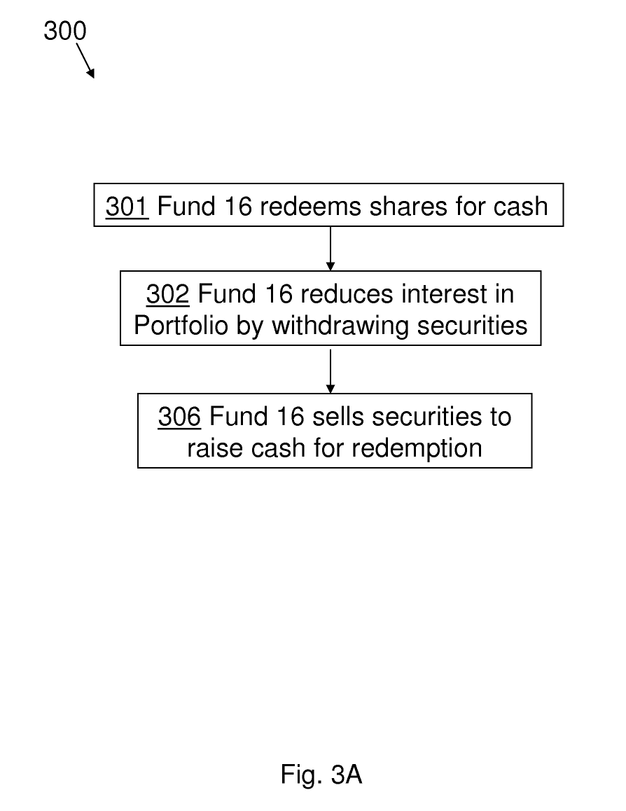

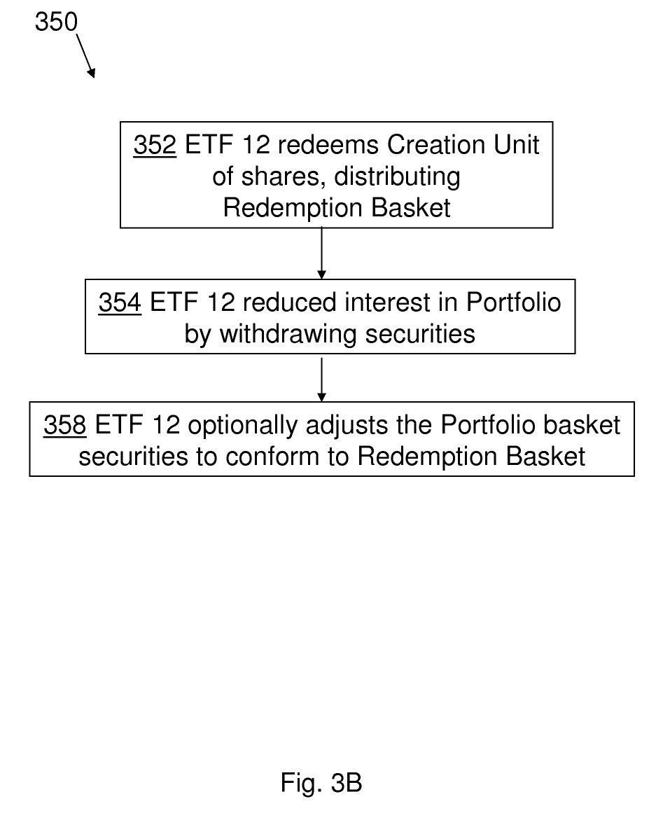

Having described exemplary embodiments of a system in accordance with the present invention, methods of using these embodiments, including operation of an automated system such as the automated fund system 150, will now be described as illustrated by the flow charts of FIGS. 2A-3B.

As discussed hereinabove, a conventional mutual fund employing a master-feeder structure would typically use cash invested by shareholders to acquire an interest in an underlying master portfolio that would purchase and hold securities. When the feeder fund needed cash to meet shareholder redemptions, the feeder fund would withdraw cash from the master portfolio, sourced either from the master portfolio's cash on hand or the sale of master portfolio securities. Substantially all transactions between the master portfolio and the feeder in the conventional master-feeder arrangement would normally be in cash.

This conventional approach is contrasted by the embodiments of the present invention described above, the operation of which is now described in detail. Methods for creating shares in Master Portfolio and disseminating them to investors through both feeder modules 12 and 16 are shown.

Turning now to FIG. 2A, a method 200 for investing in Master Portfolio 14 via Fund module 16 includes Fund module 16 receiving 210 incoming shareholder cash and issuing a corresponding value of Fund shares via transaction 22. Fund module 16 then uses this cash to purchase 212 securities from secondary market 11 via transaction 29 (FIG. 1B). As described above, the securities purchased at 212 correspond to an asset configuration (basket) specified by the Master Portfolio module 14 and disseminated to Fund module 16 at 26. Fund module 16 then exchanges 214 the purchased securities for an interest in the Master Portfolio at transaction 28. In this manner, transaction costs associated with the purchase 212 of the securities are incurred within Mutual Fund 16, rather than being borne by the Master Portfolio 14. Isolating these costs to Mutual Fund module 16 protects investors in ETF 12 from bearing a portion of such costs.

Turning now to FIG. 2B, a method 250 for investing in Master Portfolio 14 via ETF module 12 includes receiving 252 Creation Basket securities and/or cash from AP 20 and issuing a corresponding value of ETF shares in Creation Unit aggregations via transaction 30 (FIG. 1B). As discussed above, the particular configuration of the Creation Basket 26′ may be specified by Fund 12, and in particular embodiments, may be configured to have some defined level of correspondence (overlap) with the asset configuration disseminated by portfolio module 14 at 26. At 256, ETF module 12 optionally adjusts the Creation Basket securities as needed to conform to the current Master Portfolio configuration 26. At 258, ETF module 12 then distributes the

Creation Basket securities and cash, as optionally adjusted, to Master Portfolio 14 in exchange for receipt 260 of an interest in the Master Portfolio 14, at transaction 32. It should be noted that any purchases and sales of securities at 256 are made by ETF 12, e.g., via a market transaction 29, and not by the Master Portfolio 14. In this manner, as with Mutual Fund 16′s investment in the Master Portfolio 14, the transaction costs associated with ETF share issuances are incurred by ETF module 12 rather than within the Master Portfolio 14, thereby protecting Mutual Fund shareholders from bearing a portion of such costs.

As shown in FIG. 3A, Mutual Fund 16 provides for its cash needs in connection with shareholder redemptions at 300. At 301, Fund 16 redeems shares 18 for cash. To meet the redemption, Fund module 16 first withdraws 302 securities from Master Portfolio 14 and correspondingly reduces its interest in the Portfolio 14. Mutual Fund module 16 would then normally sell 306 the withdrawn securities at the fund level via market transaction 29 to provide the cash to be distributed to the redeeming shareholder. Transaction costs and potential gain realizations associated with the sale 306 of the securities are incurred within Mutual Fund module 16 rather than the Master Portfolio 14, protecting ETF shareholders from potential exposure to the associated costs and tax liabilities.

As shown in FIG. 3B, ETF module 12 redemption method 350 includes ETF module 12 redeeming shares in Creation Unit aggregations from Authorized Participants 20 at 352, distributing the current Redemption Basket of securities and cash. ETF module 12 withdraws 354 securities from Master Portfolio 14 and correspondingly reduces its interest in the Portfolio 14 via transaction 32. Optionally, at 358, ETF module 12 may then make whatever sales and/or purchases, via market transactions 33, that may be required to conform the securities withdrawn at 354 to the current Redemption Basket disclosed at 26′. As discussed above, it is expected that in particular embodiments, the configuration of the Redemption Basket 26′ may be configured to have some level of correspondence (overlap) with the asset configuration disseminated by Portfolio module 14 at 26. As above, the transaction costs and potential tax realizations associated with ETF shareholder redemptions are incurred at the feeder fund module 12 level rather than within the Master Portfolio 14, protecting Mutual Fund shareholders from potential exposure to the associated costs and tax liabilities.

The foregoing approach enables an ETF and mutual fund of the same sponsor to combine their investment operations to achieve the benefits of economies of scale, while shielding their respective shareholder groups from increased costs and potential tax liabilities in connection with the other feeder fund's shareholder activities. New ETFs may be created that substantially replicate current mutual funds, piggybacking on the existing fund's scale advantages without diluting the trading cost and tax efficiency advantages of the ETF structure.

Existing mutual funds may be effectively converted into an embodiment of the present invention via a tax-free exchange of assets into a newly created master portfolio. Such an exchange would give investors the aforementioned benefits of the present invention without creating a taxable event associated with the initial transfer.

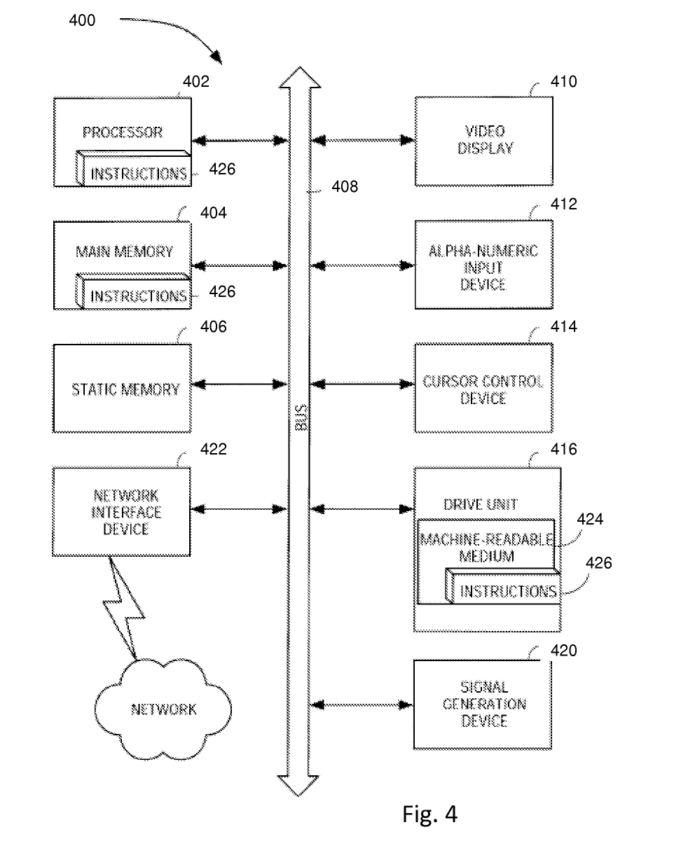

FIG. 4 shows a diagrammatic representation of a machine in the exemplary form of a computer system 400 within which a set of instructions for causing the machine to perform any one of the methodologies or portions thereof as discussed above, may be executed. Any number of these systems 400 may be used to form system 150 discussed hereinabove. In various embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 400 includes a processor 402, a main memory 404 and a static memory 406, which communicate with each other via a bus 408. The computer system 400 may further include a video display unit 410 (e.g., a liquid crystal display (LCD), plasma, cathode ray tube (CRT), etc.). The computer system 400 may also include an alpha-numeric input device 412 (e.g., a keyboard or touchscreen), a cursor control device 414 (e.g., a mouse), a drive (e.g., disk, flash memory, etc.,) unit 416, a signal generation device 420 (e.g., a speaker) and a network interface device 422.

The drive unit 416 includes a computer-readable medium 424 on which is stored a set of instructions (i.e., software) 426 embodying any one, or all, of the methodologies described above. The software 426 is also shown to reside, completely or at least partially, within the main memory 404 and/or within the processor 402. The software 426 may further be transmitted or received via the network interface device 422. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories and optical and magnetic disks.

Thus, a method and apparatus for combining the management and administration of mutual fund and exchange-traded fund assets using a master-feeder arrangement have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Furthermore, embodiments of the present invention include a computer program code-based product, which includes a non-transitory computer readable storage medium having program code stored therein which can be used to instruct a computer to perform any of the functions, methods and/or modules associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be noted that the various modules and other components of the embodiments discussed hereinabove may be configured as hardware, as computer readable code stored in any suitable non-transitory computer usable medium, such as ROM, RAM, flash memory, phase-change memory, magnetic disks, etc., and/or as combinations thereof, without departing from the scope of the present invention.

It should be further recognized that any actions described as being taken by the various modules shown and described herein, including the various exchanges of securities and/or cash described hereinabove, may be effected electronically, with or without a corresponding exchange of physical assets.

Moreover, any of the features described with respect to one of the embodiments described herein may be similarly applied to any of the other embodiments described herein without departing from the scope of the present invention.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer-implemented method for combining the Management and Administration of Mutual Fund and Exchange-Traded Fund Assets Using a Master-Feeder Arrangement, the method comprising:
(a) associating a Mutual Fund module with a feeder mutual fund that issues and redeems mutual fund shares in transactions with investors primarily for cash;
(b) associating an Exchange Traded Fund (ETF) module with a feeder ETF that issues and redeems ETF shares in transactions with Authorized Participants through one or more of in kind transfers of securities and cash;
(c) associating a Master Portfolio module with a master portfolio of investments that issues and redeems interests in the master portfolio in one or more of in-kind and cash transactions with the Mutual Fund and the ETF;
(d) communicably coupling the Master Portfolio module in a master-feeder arrangement with the Mutual Fund module and the ETF module;
(e) directing, with the Master Portfolio module, the Mutual Fund module to apply cash invested by the mutual fund investors to purchase securities in accordance with an asset configuration communicated by the master portfolio module;
(f) directing, with the Master Portfolio module, the ETF module to conform the composition of the one or more of securities and cash received in the in-kind transactions with the Authorized Participant, with said asset configuration; and
(g) directing, with the Master Portfolio module, the Mutual Fund module and the ETF module to effect increases in interests in the master portfolio by contributing said asset configuration to effect investor purchases, wherein transactions in securities to accommodate feeder fund inflows occur outside of the master portfolio;
wherein both the feeder mutual fund and the feeder ETF hold indirect interests in securities of the master portfolio, as well as transitory direct investments in securities in connection with shareholder purchases and redemptions.

2. The method of claim 1, further comprising directing, with the Master Portfolio module, the Mutual Fund module and the ETF module to pay transaction fees to the Master Portfolio in connection with transfers to or from the Master Portfolio of cash or securities that do not comport with said asset configuration, with the amount of such fees intended to offset trading and other costs to the Master Portfolio to conform the transferred cash or securities to said asset configuration.

3. The method of claim 1, wherein the modules comprise computer readable instructions disposed on a non-transitory computer readable medium.

4. The method of claim 1, further comprising processing one or more of the modules with one or more processors.

5. The method of claim 1, comprising reversing one or more of said (e)-(g) to effect investor redemptions, wherein transactions in securities to accommodate feeder fund outflows occur outside of the master portfolio.

6. The method of claim 5, further comprising (h) directing the master portfolio to effect reductions in the feeder funds' interests therein by distributing securities to the feeder funds.

7. The method of claim 6, further comprising (i) directing the mutual fund to provide cash to meet net redemptions of its shareholders by reducing its interest in the master portfolio and selling the distributed securities.

8. The method of claim 7, further comprising (j) directing the ETF feeder to meet its net redemptions by reducing its interest in the master portfolio, and distributing the securities received as its Redemption Basket.

9. The method of claim 8, further comprising transacting securities at the feeder fund level to conform the distributed securities to the Redemption Basket.

10. The method of claim 8, comprising tracking and recording investments and redemptions.

11. The method of claim 1, comprising configuring the mutual fund, the ETF, and the master portfolio to all have the same sponsor.

12. The method of claim 1, comprising directing, with the Mutual Fund module, the mutual fund to purchase and sell securities via a secondary market.

13. The system of claim 12, comprising directing, with the Mutual Fund module, the mutual fund to purchase and sell securities via a secondary market selected from the group consisting of the New York Stock Exchange and Nasdaq.

14. The method of claim 1, comprising directing, with the ETF module, the ETF to purchase and sell securities via a secondary market.

15. The system of claim 14, comprising directing, with the ETF module, the ETF to purchase and sell securities via a secondary market selected from the group consisting of the New York Stock Exchange and Nasdaq.

16. The method of claim 14, comprising directing, with the ETF module, the ETF to conform said composition of securities with said asset configuration by the purchase and sale of securities via a secondary market.

17. The method of claim 14, comprising directing, with the ETF module, the ETF to conform said composition of securities with said asset configuration by configuring at least one of a Creation Basket and Redemption Basket of the ETF to match said asset configuration.

18. The method of claim 1, further comprising directing the master portfolio to effect transactions with a secondary market and to impose transaction charges for the transactions on the feeder funds.

19. An article of manufacture for combining the Management and Administration of Mutual Fund and Exchange-Traded Fund Assets Using a Master-Feeder Arrangement, said article of manufacture comprising a computer usable medium having a computer readable program code embodied therein for implementing the method of claim 1.

20. A computer-implemented system for combining the Management and Administration of Mutual Fund and Exchange-Traded Fund Assets Using a Master-Feeder Arrangement, the system comprising:
a Mutual Fund module configured to direct operation of a feeder mutual fund that issues and redeems mutual fund shares in transactions with investors primarily for cash;
an Exchange Traded Fund (ETF) module configured to direct operation of a feeder ETF that issues and redeems ETF shares in transactions with Authorized Participants through one or more of in kind transfers of securities and cash;
a Master Portfolio module configured to direct operation of a master portfolio of investments that issues and redeems interests in the master portfolio in one or more of in-kind and cash transactions with the Mutual Fund module and the ETF module;
the Master Portfolio module configured for being communicably coupled in a master-feeder arrangement with the Mutual Fund module and the ETF module;
the Master Portfolio module configured to direct the Mutual Fund module to apply cash invested by the mutual fund investors to purchase securities in accordance with an asset configuration communicated by the master portfolio module;
the Master Portfolio module configured to direct the ETF module to conform the composition of the one or more of securities and cash received in the in-kind transactions with the Authorized Participant, with said asset configuration;
the Master Portfolio module configured to direct the Mutual Fund module and the ETF module to effect increases in interests in the master portfolio by contributing said asset configuration to effect investor purchases, wherein transactions in securities to accommodate feeder fund inflows occur outside of the master portfolio; and
one or more processors configured to process the modules;
wherein both the feeder mutual fund and the feeder ETF are configured to hold indirect interests in securities of the master portfolio, as well as transitory direct investments in securities in connection with shareholder purchases and redemptions.

21. The system of claim 20, wherein the Master Portfolio module is configured to direct the Mutual Fund module and the ETF module to pay transaction fees to the Master Portfolio in connection with transfers to or from the Master Portfolio of cash or securities that do not comport with said asset configuration, with the amount of such fees intended to offset trading and other costs to the Master Portfolio to conform the transferred cash or securities to said asset configuration.

22. The system of claim 20, wherein the modules comprise computer readable instructions disposed on a non-transitory computer readable medium.

23. The system of claim 20, wherein the Master Portfolio is configured to direct the Mutual Fund module and the ETF module to effect decreases in interests in the master portfolio by withdrawing said asset configuration to effect investor redemptions, wherein transactions in securities to accommodate feeder fund outflows occur outside of the master portfolio.

24. The system of claim 23, configured to direct the master portfolio to effect reductions in the feeder funds' interests therein by distributing one or more of securities and cash to the feeder funds.

25. The system of claim 24, configured to direct the mutual fund to provide cash to meet net redemptions of its shareholders by reducing its interest in the master portfolio and selling distributed securities.

26. The system of claim 25, configured to direct the ETF feeder to meet its net redemptions by reducing its interest in the master portfolio, and distributing the securities received as its Redemption Basket.

27. The system of claim 25, configured to direct the ETF feeder to meet its net redemptions by reducing its interest in the master portfolio, and transacting in securities at the feeder fund level to conform the distributed securities to the ETF's current Redemption Basket.

28. The method of claim 27, comprising tracking and recording investments and redemptions.

29. The system of claim 20, wherein the mutual fund, the ETF, and the master portfolio all have the same sponsor.

30. The system of claim 20, wherein the master portfolio module is configured to direct transactions with a secondary market and to impose transaction charges for said transactions on the feeder funds.

31. The system of claim 20, wherein the Mutual Fund module is configured to direct the mutual fund to purchase and sell securities via a secondary market.

32. The system of claim 31, wherein the Mutual Fund module is configured to direct the mutual fund to purchase and sell securities via a secondary market selected from the group consisting of the New York Stock Exchange and Nasdaq.

33. The system of claim 20, wherein the ETF module is configured to direct the ETF to purchase and sell securities via a secondary market.

34. The system of claim 33, wherein the ETF module is configured to direct the ETF to purchase and sell securities via a secondary market selected from the group consisting of the New York Stock Exchange and Nasdaq.

35. The system of claim 33, wherein the ETF module is configured to conform said composition of securities with said asset configuration by directing the purchase and sale of securities via a secondary market.

36. The system of claim 33, wherein the ETF module is configured to conform said composition of securities with said asset configuration by configuring at least one of a Creation Basket and Redemption Basket of the ETF to match said asset configuration.
